(19) United States
(12) Patent Application Publication
(10) Pub. No.: US 2023/0136982 A1
(43) Pub. Date: May 4, 2023

(54) METHOD OF MECHANICALLY HARVESTING INNER AND OUTER MEAT FILLETS FROM POULTRY CARCASS BREAST CAPS, AND A DEVICE FOR CARRYING OUT THE METHOD

(71) Applicant: Foodmate B.V., Numansdorp (NL)

(72) Inventors: Marinus Hendrik den Boer, Numansdorp (NL); Andrianus Cornelis Johannes Hoppenbrouwers, Numansdorp (NL); Robert Jonathan Stocks, Huddersfield (GB); Michiel Manuel Johannes Gerlach, 's-Gravendeel (NL); David Scott Hazenbroek, Klaaswaal (NL)

(21) Appl. No.: 17/794,341

(22) PCT Filed: Jan. 27, 2021
(86) PCT No.: PCT/EP2021/051879

§ 371 Date: Jul. 21, 2022

Related U.S. Application Data
(60) Provisional application No. 62/966,439, filed on Jan. 27, 2020.

(51) Int. Cl. A22C 21/00

(52) U.S. Cl. CPC A22C 21/003; A22C 21/0069

(57) ABSTRACT

A method of harvesting meat fillets from a poultry carcass, wherein a poultry breast cap is supported inverse to its natural position on a carrier moving along a path of conveyance, wherein the poultry breast cap is moved past a measuring system that detects the poultry breast cap and generates information for determining an approximated size of the poultry breast cap, wherein breast meat is optionally engaged by a dynamic guide bar system, and is cut adjacent a keel bone of the poultry carcass, an outer fillet is cut along the keel bone of the poultry breast cap, wherein inner and outer fillets are separated, and wherein the poultry carcass remains are discarded.

### FIELD OF THE INVENTION

The invention relates to a method of mechanically harvesting inner and outer meat fillets from a poultry carcass breast cap, and a device for carrying out the method.

### BACKGROUND

Method and devices for filleting poultry breast caps are known. In particular applicants' U.S. Pat. No. 9,078,453 patent relates to a method and device for deboning poultry breast caps to obtain breast fillets therefrom. This method and device has been successful in harvesting breast fillets, butonly with the inner and outer fillets remaining together. It is however sometimes also required to have the inner and outer breast fillets as separate meat products. In such instances it has been necessary to separate the inner and outer breast fillets manually.

### SUMMARY

It is an object of the present invention to propose, and embodiments of the present invention seek to provide, an improved method and device for mechanically harvesting inner and outer meat fillets from poultry carcass breast caps, when such is required. In a more general sense it is an object of the invention to overcome or reduce at least one of the disadvantages of the prior art. It is also an object of the present invention to provide alternative solutions which are less cumbersome in assembly and operation and which moreover can be made relatively inexpensively. Alternatively, it is an object of the invention to at least provide a useful alternative.

To this end the invention provides an improved method of mechanically harvesting inner and outer meat fillets from a poultry carcass breast cap, and an improved device for carrying out the method as defined in the appended claims.

In the method of mechanically harvesting inner and outer meat fillets from a poultry carcass breast cap a poultry breast cap is conveyed while it is supported inversed to its natural position on a carrier through a path of conveyance. In this method the outer fillet is cut along a keel bone of the poultry breast cap, the inner and outer fillets are separated, and the carcass remains are discarded. Such a method can further include providing an endless conveyor including the carrier and continuously moving the breast cap supported on the carrier through the path of conveyance. Optionally, a measuring system can detect and generate information regarding the size, such as, e.g. approximate, length and/or width of each breast cap. The measuring system can include a three-dimensional, 3D, imaging system, such as a 3D camera, configured for obtaining a three-dimensional, 3D, image of an outer surface of the poultry carcass/poultry breast cap. The measurement system can e.g. include a triangulation based 3D laser scanner. Additionally, a furcular bone removing apparatus can be provided and a further step of conveying the poultry breast cap for engagement by the furcular bone removing apparatus for removing the furcular bone.

The method may also further comprise providing a first breast fillet working unit having laterally movable tunnel plates, and a step of engaging meat of the breast cap by the tunnel plates. Effectively the tunnel plates act as scrapers and scrape between the inner and outer fillets to promote harvesting a subsequent stage. As an additional step the method can comprise providing a breast fillet cutter for performing cutting the outer fillet along the keel bone of the poultry breast cap. Effectively the breast fillet cutter splits the outer fillet to allow harvesting thereof in two halves.

Optionally a step can be included of providing a second breast fillet working unit with a guide structure and an up-and-down movable engagement member connected to the guide structure, thereby allowing the guide structure to pass centrally over the carrier and to position the engagement member at an appropriate level. Effectively the engagement member acting as a scraper plate prepares a front portion of the outer fillet for being gripped. The engagement member is lifted by engagement with the carrier.

The method according to the invention can also include a step of providing an inner and outer fillet separator, and performing separation of the outer fillet from the inner fillet of the breast cap meat. Effectively the inner and outer fillet separator harvests the now loosened outer fillets halves by allowing guide rods to act as grippers. A tissue and/or tendon cutter can be provided having cutting knifes capable of being moved inwardly and outwardly in a direction transverse to the path of conveyance, and cutting tissue can thereby be performed by moving the cutting knives inwardly into engagement with the breast cap. Effectively the cutting knives cut between the carcass and inner fillet for promoting a cleaner harvesting of same.

The method can also further comprise a step of providing a third breast fillet working unit having inwardly and outwardly movable guides, and enabling removing the inner fillet by moving the guides outwardly after having engaged the breast cap meat. The third breast fillet working unit effectively acts as a centering unit, e.g. directly preceding an optionally provided carcass separator, allowing a step of operating the carcass separator for lifting the inner fillet from the carcass remains on the carrier, and thereby preparing the carcass remains for subsequent discarding by a carcass unloader or like implement.

The 3D imaging system 3D is configured to obtain a 3D image of an outer surface of the poultry carcass/poultry breast cap. A processor, e.g. of the 3D imaging system or controller or control system, can be configured to generate a 3D model of the poultry carcass/poultry breast cap on the basis of the 3D image. The processor can be configured to determine a length and/or width and/or height of the poultry carcass/breast cap from the 3D image and/or from the 3D model. Alternatively, or additionally, the processor can be configured to determine specific dimensions and/or relative locations of anatomical landmarks of the poultry carcass/breast cap from the 3D image and/or from the 3D model. The controller or control system can be configured to adjust a position of movable parts of the first fillet working unit, the breast fillet cutter, the second fillet working unit, the inner and outer fillet separator, the tissue and/or tendon cutting unit, the third fillet working unit, the carcass separator, and/or the carcass unloader.

The device in accordance with the invention comprises means for performing at least the steps of conveying, separating inner and outer breast fillets, and discarding carcass remains. The means for performing at least the steps of conveying, separating inner and outer breast fillets, and discarding carcass remains can comprise: an endless conveyor extending along a defined path of conveyance; at least one breast cap carrier arranged for being moved through the predefined path of conveyance by an endless conveyor; a first breast fillet working unit positioned in the path of conveyance; an optional breast cutter downstream of the first breast fillet working unit in the path of conveyance; a second fillet working unit downstream of the breast cutter in the path of conveyance; an inner and outer fillet separator unit downstream of the breast cutter in the path of conveyance; a tissue cutting unit downstream of the inner and outer fillet separator in the path of conveyance; a third fillet working unit downstream of the tissue cutting unit in the path of conveyance; and a carcass separator unit downstream of the third fillet working unit in the path of conveyance. Such a device can further comprise a carcass unloader downstream of the carcass separator unit in the path of conveyance defined by the conveyor.

Optionally, the device can further comprise a common frame beam extending parallel to the path of conveyance for mounting one or more of the means for performing at least the steps of conveying, separating inner and outer breast fillets, and discarding carcass remains, while attaching same by mounting strips engaging over the common frame beam.

A measuring system, e.g. as described above, also can be provided along the path of conveyance of the poultry carcasses, downstream from a loading point or station at which the poultry carcasses/poultry breast caps are loaded onto the carriers. The measuring system generally can include a camera or similar imaging device that can capture an image of each poultry carcass. The image will be communicated to a controller that can determine start and end points and/or an approximate size of each carcass for use in controlling actuation of downstream cutting stations, and/or for potentially adjusting operative elements (i.e., cutting blades, guides, etc. . . . ) thereof.

In the device according to the invention, the first breast fillet working unit can comprise a pair of opposite arm elements each carrying a tunnel plate, together forming a pair of laterally movable tunnel plates, and opposite pneumatic cylinders for moving the opposite tunnel plates to and from one another. The first breast fillet working unit, acting as an outer fillet scraper, with its tunnel plates scrapes between the inner and outer fillet, which enhances harvesting by the second breast fillet working unit acting as an outer fillet harvester.

The optional breast cutter can comprise a motor drive unit for rotatably driving the double circular cutting blades and/or the double circular cutting blades are height adjustable with respect to the path of conveyance. The optional breast cutter, acting as a breast fillet splitter, cuts the fillet in half so that two halves of outer fillets can be harvested.

In addition, a dynamic guide bar system can be used with the optional breast cutter, or with other cutting stations such as the first and/or second breast fillet working stations. In one embodiment, the dynamic guide bar system can include one or more wheels or other rotatable members mounted adjacent the cutting blades of the optional breast cutter. The wheels rotate with the cutting blades and, as they rotate, they carry a series of flexible fingers or guide bars into engagement with the poultry carcass. The flexible guide bars or fingers engage and urge the meat of the breast away from the keel bone so that as the breast meat is cut away from the keel bone by the cutting blades, an increased portion of the meat can be maintained with the breast fillets, leaving less meat remaining with the carcass. Still further, adjustable tender guides, each having cutting blades or knives attached thereto can be located adjacent the optional breast cutter. The adjustable tender guides can be moved between a first, retracted or non-engaging position and a second, extended or engaging position as needed or desired for selectively cutting the tender portions of the breast meat with the outer breast fillets as the beast fillets are cut away from the carcass.

The second breast fillet working unit can have an up-and-down movable engagement member connected to a guide structure, and wherein the guide structure is arranged for engagement by the at least one breast cap carrier for positioning of the engagement member. The second breast fillet working unit, acting as an outer fillet scraper, loosens the front part of the outer fillet for later gripping by the inner and outer fillet separator, effectively acting as an outer fillet harvester. An engagement member acting as a scraper plate is mechanically lifted when it is engaged by a passing carrier.

The inner and outer fillet separator can comprise pivotable guide rods operated by pneumatic actuators for separation of the outer fillet from the inner fillet of the breast cap meat. The inner and outer fillet separator acts as an outer fillet harvester by means of the two pivotable guide rods engaging the loose hanging outer fillet and harvests the outer fillet halves by unloading after the carrier has passed.

The tissue cutter can comprise inwardly and outwardly movable cutting knives capable of being moved in a direction transverse to the path of conveyance and thereby are arranged for cutting tendon tissue when in use the cutting knives are moved inwardly into engagement with the breast cap. The tissue cutter, thus acting as an inner fillet tendon cutter, cuts between the carcass and the inner fillet to enable a cleaner harvesting by the carcass separator, which separates and harvests the inner fillet.

The third breast fillet working unit amongst others can comprise inwardly and outwardly movable guides arranged for removing the inner fillet by movement of the inwardly and outwardly movable guides outwardly when engaging the breast cap meat. The third breast fillet working unit, which directly precedes the carcass separator, centers the inner fillet by pressing two forwardly protruding bones of the carcass for engagement by the associated carcass separator for harvesting the inner fillet.

The carcass separator, which is in association with the third breast fillet working unit, can comprise a pneumatically operated lifting arm arranged for lifting the carcass remains from the carrier. The carcass separator, acting effectively as an inner fillet harvester, scrapes the now almost loose inner fillet completely loose from the carcass by severing the remaining tendon tissue.

The described setup also allows harvesting of half breast fillets with the inner and outer fillet parts attached to one another. This is accomplished by the various implements for performing the breast cap working steps allowing ready rearrangement for this purpose.

The least one breast cap carrier can include a spring biased clamp for holding a poultry breast cap on the carrier.

It will be appreciated that all features and options mentioned in view of the method apply equally to the device, and vice versa. It will also be clear that any one or more of the above aspects, features and options can be combined.

### BRIEF DESCRIPTION OF THE DRAWINGS

Advantageous aspects of the invention will become clear from the appended description and in reference to the accompanying drawings, in which:

FIG. 1A is an isometric view of a breast filleting machine.

FIGS. 1B-1C are views of an upper portion of the breast filleting machine, illustrating a measuring system for detecting and generating measurements of poultry breast caps loaded into the machine.

FIG. 2 is an assembly for incorporation into the breast filleting machine of FIG. 1 for performing the method of the invention.

FIG. 3 is a side elevation of the assembly of FIG. 2.

FIG. 4 is a carrier for use with the machine and assembly in a position ready to receive a poultry breast cap.

FIG. 5 is the carrier of FIG. 4 with the poultry breast cap in position.

FIG. 6 is a first breast fillet working unit.

FIG. 7 is a breast fillet cutter.

FIG. 8 is a second breast fillet working unit.

FIG. 9 is an inner and outer fillet separator.

FIG. 10 is a tissue cutter.

FIG. 11 is a third breast fillet working unit.

FIG. 12 is a carcass separator.

FIGS. 13A-13G are sequential views illustrating a dynamic guide bar system for engaging and guiding portions of the meat of a poultry carcass being conveyed through the machine for cutting and harvesting of the meat.

FIGS. 14A-14D are views illustrating a dynamic guide bar system for engaging and guiding portions of the meat of a poultry carcass being conveyed through the machine for cutting and harvesting of the meat.

FIG. 15 is a perspective view of the adjustable tender guides.

FIG. 16 is a picture showing outer breast fillets with tender portions maintained therewith and removed.

### DETAILED DESCRIPTION

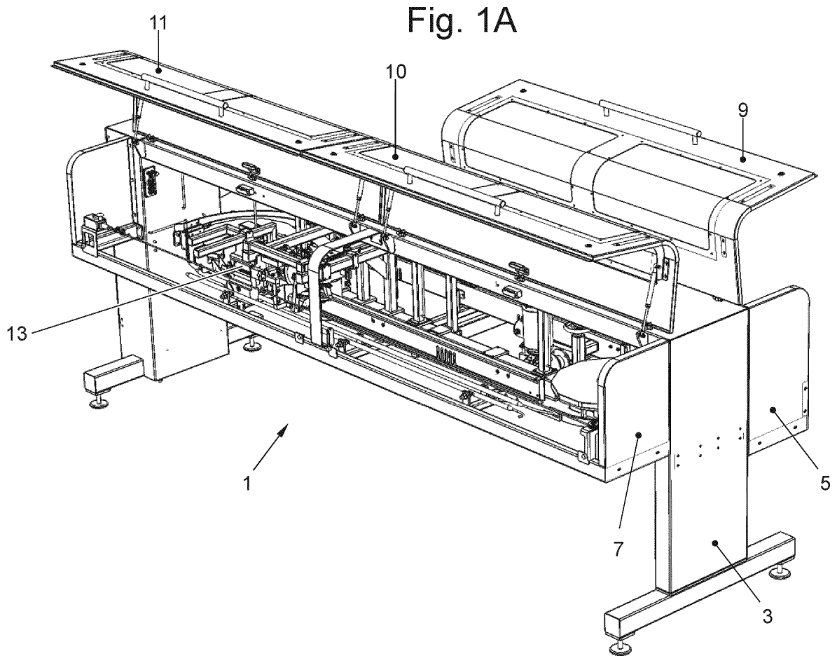

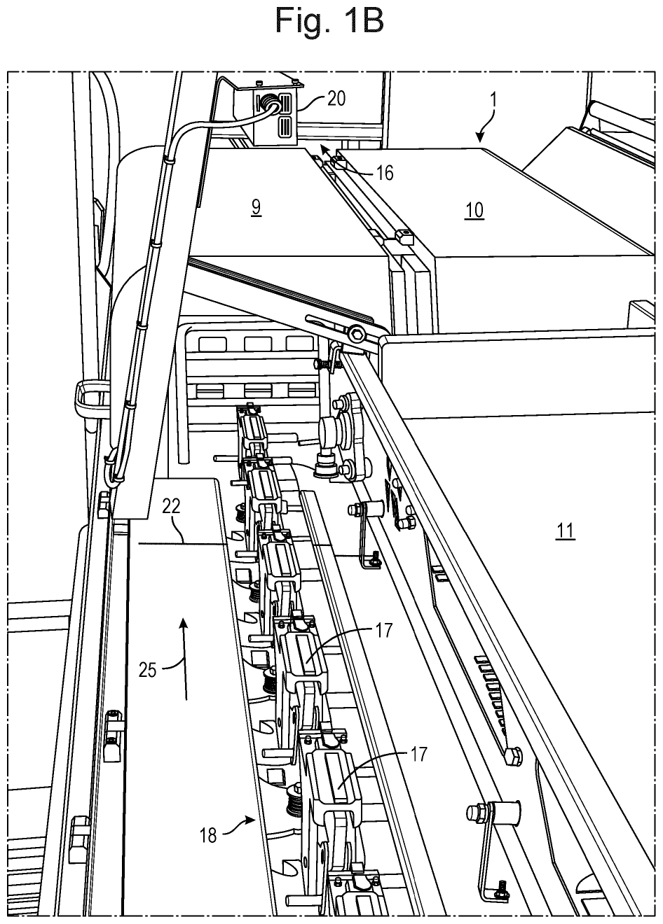

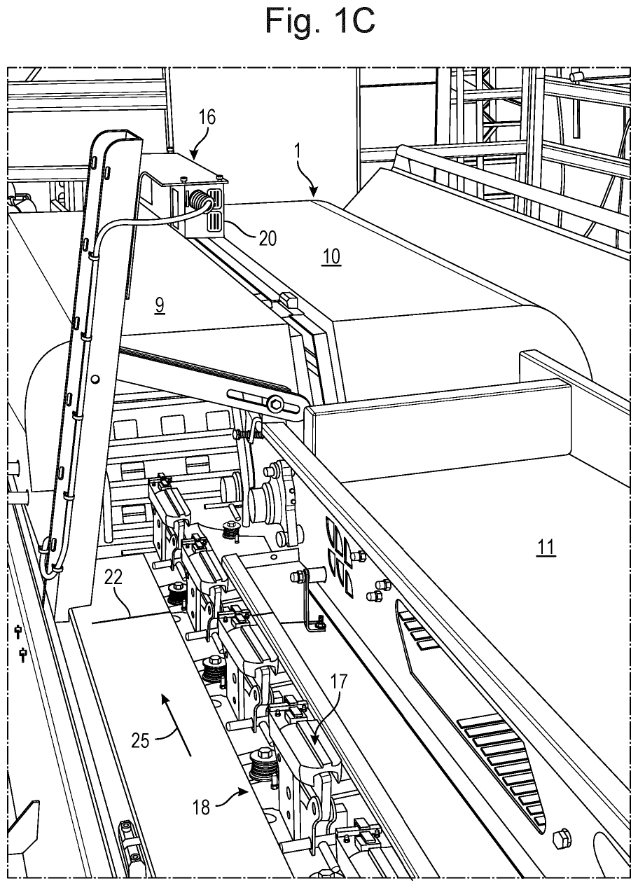

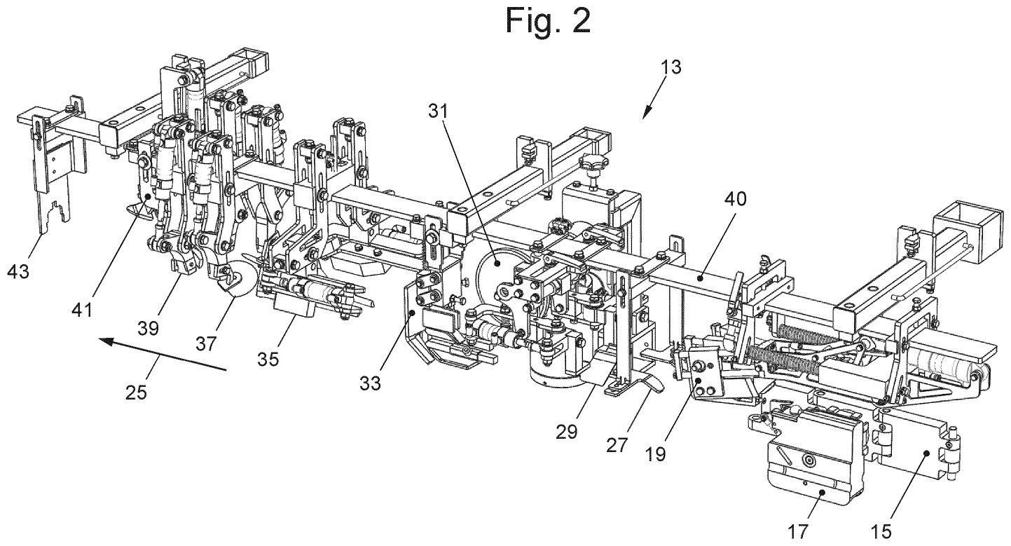

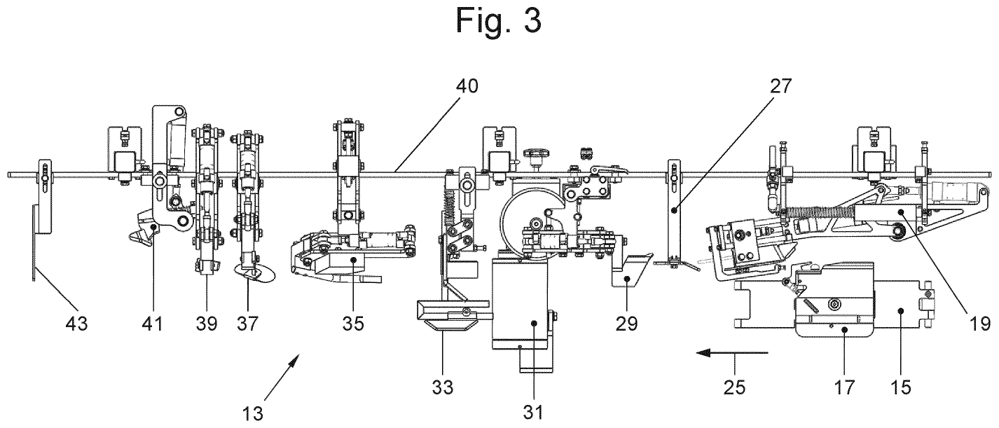

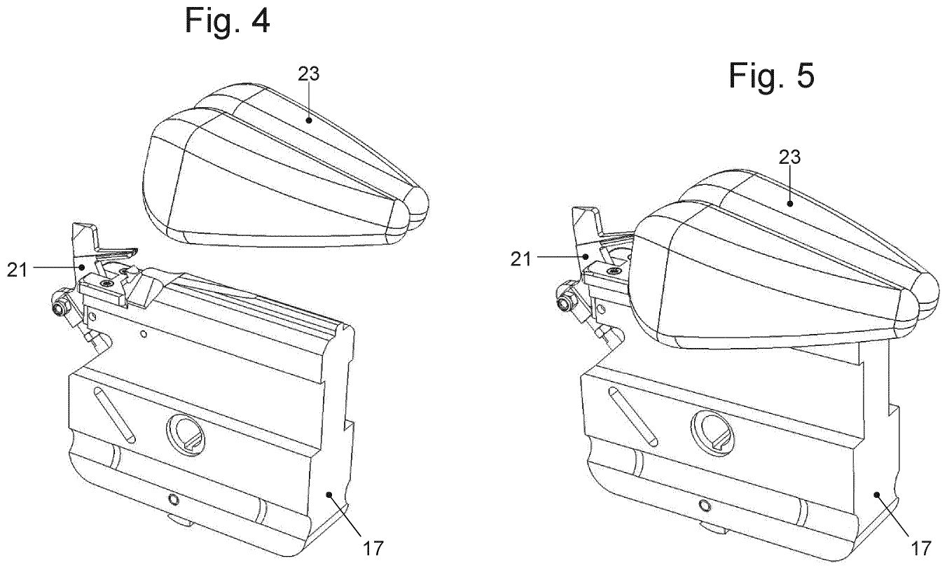

The machine 1 illustrated in FIG. 1 is generally of a type described in applicant's U.S. Pat. No. 9,078,453 patent. It comprises a main frame 3, to which are attached a front cabinet 5 and a rear cabinet 7. The front and rear cabinets 5,7 can be closed by hatches 9, 10, 11. Behind the hatches on the rear cabinet 7 is housed an inner and outer breast filleting assembly 13. The inner and outer breast filleting assembly is shown in greater detail in FIGS. 2 and 3 and cooperates with an endless conveyor 15, which carries a plurality of breast cap carriers 17 through a path of conveyance extending along the machine 1. For clarity only one breast cap carrier 17 is shown in FIGS. 2 and 3, but the arrangement is well known and described in applicant's U.S. Pat. No. 9,078,453 as referred to above. On the right hand side of FIGS. 2 and 3 is shown a furcula removing apparatus 19. This apparatus removes the furcula or wishbone from the carcass but is not part of the present invention. The furcula removing apparatus 19 is described in detail in applicant's patent application NL 2015436, entitled “Apparatus, system and method for removing furculae from poultry breast caps”. As shown in FIGS. 4 and 5 the carrier body or mandrel 17 has a spring biased clamp 21 for holding a poultry breast cap 23 in an inverted position. FIG. 4 shows the breast cap 23 before being positioned on the carrier body 17, and FIG. 5 shows the breast cap 23 engaged over the carrier 17 while it is being held by the spring biased clamp 21.

As shown in FIGS. 1B and 1C, a measurement system 16 can be mounted along the path of conveyance extending through the machine 1. The measurement system 16 can generally be located along an upper portion of the frame of the machine, e.g. adjacent a loading area 18 at which the poultry carcasses/poultry breast caps are loaded onto each of the breast cap carriers 17. The measurement system 16 generally will include a camera 20 or other, similar imaging device. More specifically the measurement system 16 includes a three-dimensional, 3D, imaging system, such as a 3D camera, configured for obtaining a three-dimensional, 3D, image of an outer surface of the poultry carcass/poultry breast cap. In this example the measurement system includes a triangulation based 3D laser scanner. A projected laser line is illustrated at 22 in FIGS. 1B-1C. However, alternative 3D imaging systems can be employed, such as stereo cameras, structured light imaging systems, or the like. The measurement system 16 in this example is mounted facing downwardly over the path of conveyance of the breast cap carriers. The measurement system 16 can be configured, and in a position, to detect a leading or first portion of each poultry breast cap and a second, rear or trailing end portion thereof. The measurement system 16, e.g. the camera or other imaging device 20, further can include a laser or similar detector or measurement sensor that detects the first or leading end of the poultry breast cap and the second or trailing end thereof, such as illustrated at 22 in FIGS. 1B-1C.

The image or other measurement information captured by the measurement system 16, e.g. the camera, will be used to generate or determine an approximate length of each poultry breast cap prior to engagement by a first cutting module or station. In addition, other measurements such as a width and/or height of each poultry breast cap further can be determined based upon the image of each poultry breast cap taken by the measurements system 16, e.g. the camera. This information can be provided to a controller or control system for the machine 1, which can calculate or determine a size, e.g. an approximate size, e.g. a length and/or width, of each breast cap.

The 3D imaging system 3D is configured to obtain a 3D image of an outer surface of the poultry carcass/poultry breast cap. A processor, e.g. of the 3D imaging system or controller or control system, can be configured to generate a 3D model of the poultry carcass/poultry breast cap on the basis of the 3D image. For example, a model of the breast cap can be generated, substantially approximating the size and/or configuration of each poultry breast cap. Using this information, the operation of the various downstream modules or cutting stations can be initiated (e.g. started and stopped) and/or otherwise controlled to help enhance the accuracy of the cutting therein. In addition, various adjustments to such modules also potentially can be made, such as adjusting guides or cutting blades thereof, to accommodate for variations in the sizes and/or configurations of each poultry breast cap. More specifically, the processor can be configured to determine a length and/or width and/or height of the poultry carcass/breast cap from the 3D image and/or from the 3D model. Alternatively, or additionally, the processor can be configured to determine specific dimensions and/or relative locations of anatomical landmarks of the poultry carcass/breast cap from the 3D image and/or from the 3D model. The controller or control system can be configured to adjust a position of movable parts of a first fillet working unit 29, a breast cutter 31, a second fillet working unit 33, an inner and outer fillet separator unit 35, a tissue cutting unit 37, a third fillet working unit 39, an associated carcass separating unit 41, and/or a carcass unloader 43.

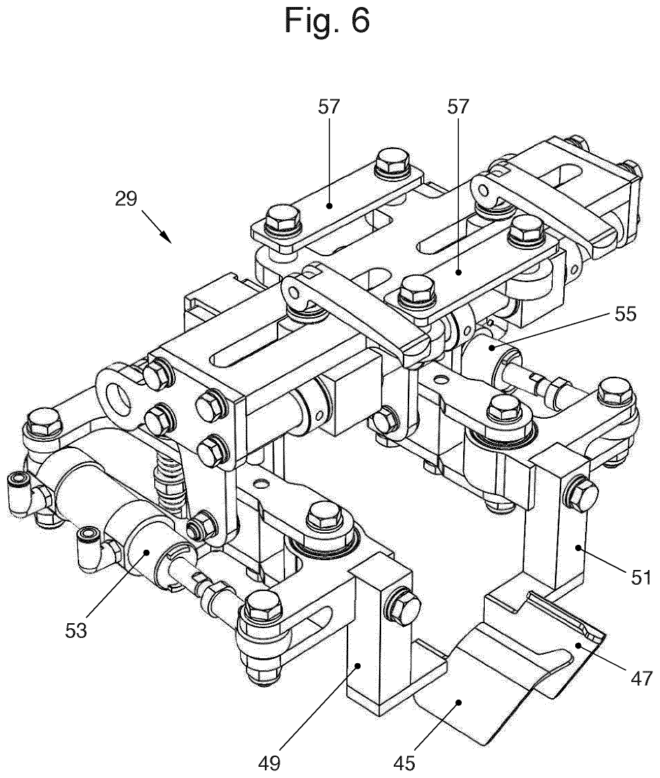

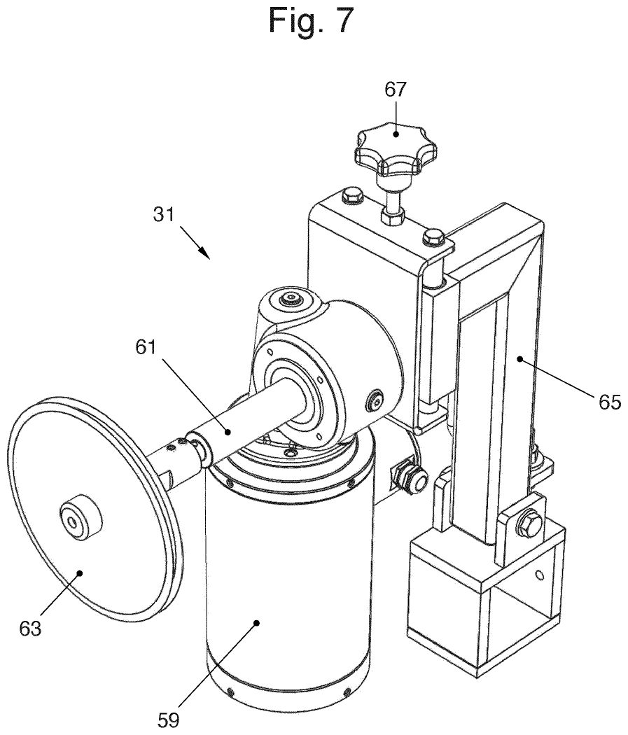

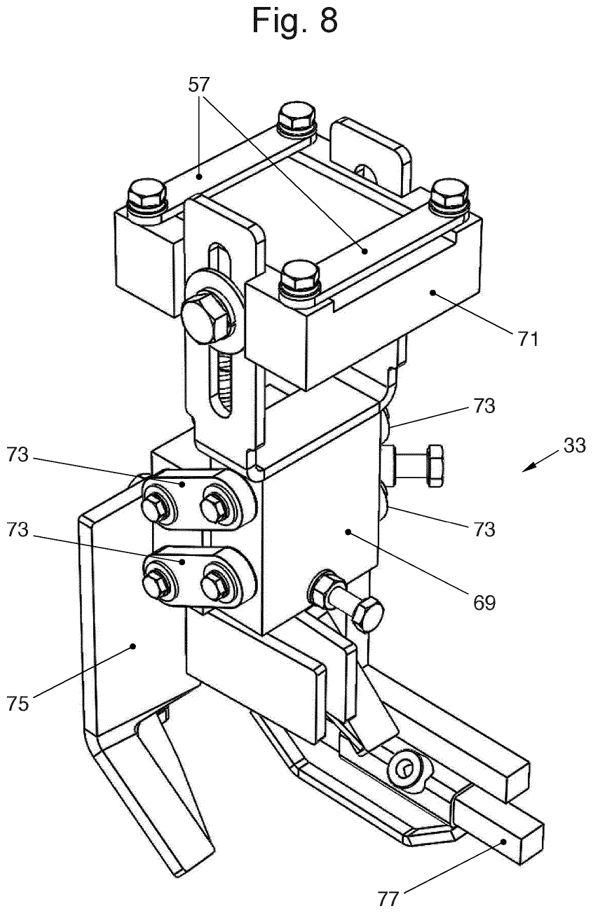

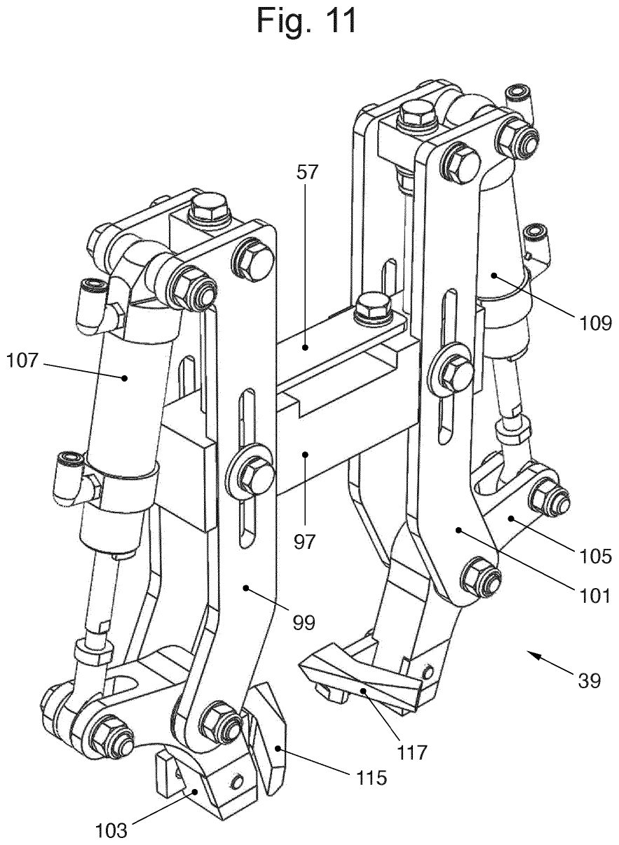

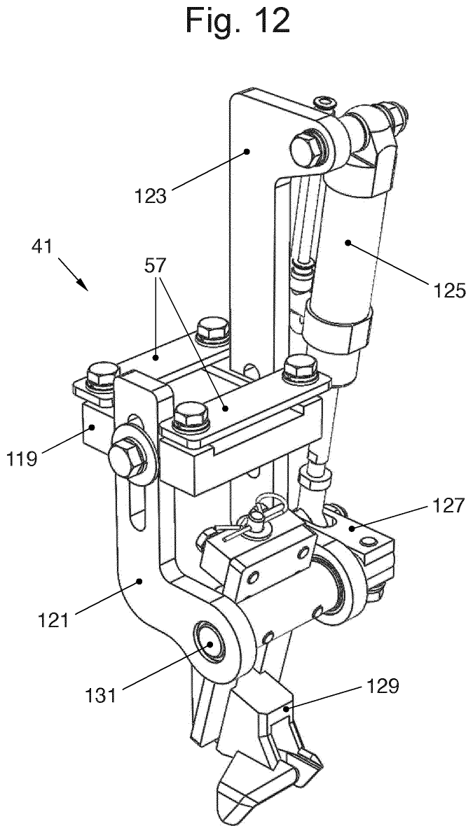

Returning now to FIGS. 2 and 3 it is to be understood that each carrier 17 with a breast cap 23 in position thereon moves along the assembly 13 of FIGS. 2 and 3 from the right hand side to the left hand side in the direction of arrow 25. A breast cap 23, after its furcular bone has been removed by the apparatus 19, first engages a guide structure 27 which guides the meat of the breast cap for engagement by a first fillet working unit 29 (shown in FIG. 6). After passing the first fillet working unit 29 the carrier 17 moves the breast cap to a breast cutter 31 (shown in FIG. 7). From the breast cutter 31, which cuts the breast cap meat along its keel bone, the breast cap is moved to a second fillet working unit 33 (shown in FIG. 8). Upon passing the second fillet working unit 33, the breast cap engages an inner and outer fillet separator unit 35. From the inner and outer fillet separator unit 35 the breast cap progresses to tissue cutting unit 37 (shown in FIG. 10) and thence to a combination of a third fillet working unit 39 (shown in FIG. 11), and an associated carcass separating unit 41 engaging the remaining breast cap meat forming the inner fillet or tender (further shown in FIG. 12). Effectively the third fillet working unit 39 acts as a guiding implement for the carcass separating unit 41, which removes the inner fillet or tender. Finally, the breast cap carcass after removal of the inner and outer meat fillets is unloaded by the carcass unloader 43. The successive units are all mounted on a common frame beam 40.

Having now regard to FIG. 6, the first breast fillet working unit 29 is seen to have a pair of opposite tunnel plates 45, 47 each mounted on a respective arm element 49, 51. The arm elements 49, 51 are each pivoted about a vertically extending axis, so that the tunnel plates 45, 47 can be moved to and from the position shown in FIG. 6 by opposite pneumatic cylinders 53, 55. The controller or control system can be configured to operate the pneumatic cylinders 53, 55 on the basis of the 3D image and/or 3D model. For instance, the position relative to a leading end of the breast cap where the arm elements 49, 51 start engaging the breast cap can be controlled on the basis of the 3D image and/or 3D model. Mounting strips 57 are provided for mounting of the first breast fillet working unit 29 to the common frame strip 40 (shown in FIGS. 2 and 3). The first breast fillet working unit 29 acts as an outer fillet scraper, by scraping with the tunnel plates 45, 47 between the inner and outer fillet. This loosens the outer fillet and enhances harvesting by the second breast fillet working unit 33, which will act as an outer fillet harvester.

The breast cutter 31 as shown in FIG. 7, is seen to have a motor drive unit 59 for driving a shaft 61, which carries the double circular cutting blades 63. The double circular cutting blades 63 cut the meat on each side of the keel bone of the breast cap, and are height adjustably mounted on an outrigger 65. Height adjustment is by means of knurled wheel 67 in this example. Alternatively, the height adjustment can be performed using an automated actuator (not shown). The controller or control system can be configured control the height of the double circular cutting blades 63 on the basis of the 3D image and/or 3D model. The breast cutter 31, which is optional, splits the outer breast fillet in half so that the outer fillets can be harvested in two halves.

The second breast fillet working unit 33 shown in FIG. 8 has a central body 69, which height adjustably depends from an overhead mounting base 71, which is attachable to the common frame beam 40 by means of mounting strips 57. The central body 69 has anchored thereto opposite parallel pivot arms 73, which carry an engagement member 75 for up-and-down movement parallel to the central body 69. The engagement member 75 has a guide structure 77, which passes centrally over the breast cap carrier 17. The second breast fillet working unit 33 scrapes the outer fillet and loosens a front part thereof for subsequent gripping by the inner and outer fillet separator 35 for harvesting the outer fillet halves. The engagement member 75 acts as a scraper plate and is mechanically lifted when it is engaged by a passing breast cap carrier 17. Alternatively, the vertical position of the engagement member 75 can be controlled using an automated actuator (not shown). The controller or control system can be configured control the vertical position of the engagement member 75 on the basis of the 3D image and/or 3D model. The engagement member 75 can e.g. be controlled to follow a path relative to the breast cap. The processor can be arranged to estimate a position of lower side of the outer fillet halves on the basis of the 3D image of the 3D model, even though the lower side of the outer fillet halves is not visible in the 3D image of the outer surface of the breast cap. The relationship between the outer surface of the breast cap and the lower side of the outer fillets can easily be determined by some simple experimentation, e.g. by manually removing outer fillets on a number of breast caps positioned on a breast cap carrier. The path can be a, e.g. curved, path following the estimated vertical position of the lower side of the outer fillet halves.

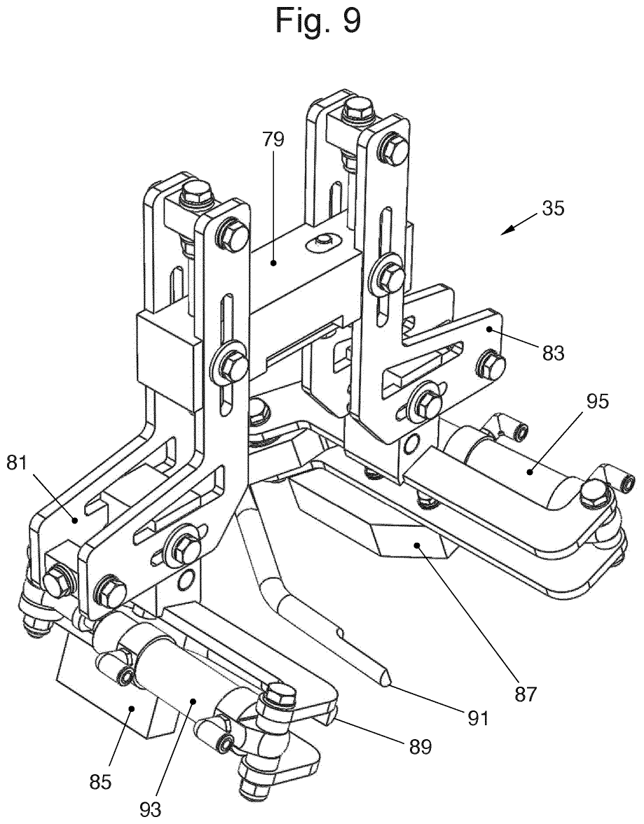

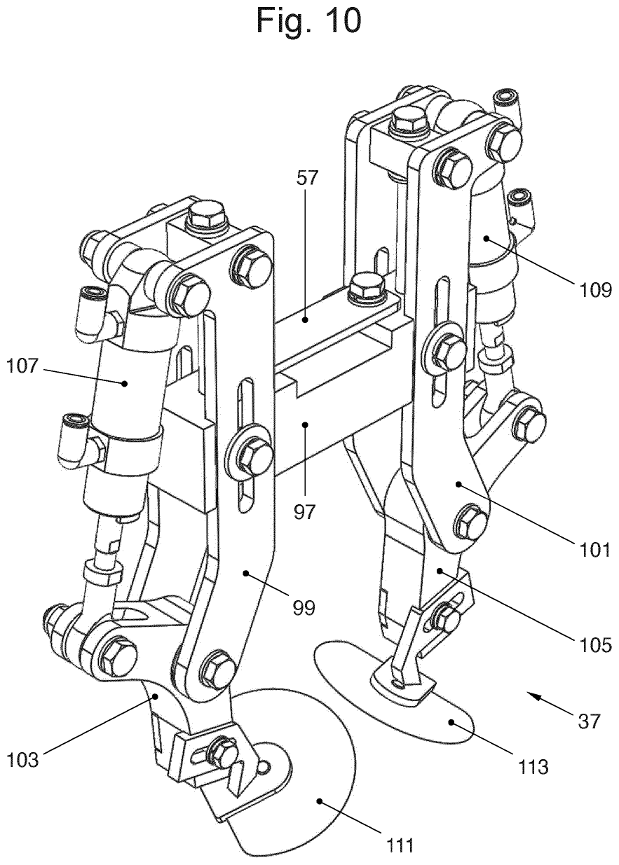

The inner and outer fillet separator 35 shown in FIG. 9 has a mounting bracket 79 for mounting over the common frame beam 40. Depending opposite side frames 81, 83 are height adjustably mounted to the mounting bracket 79, and each carry a respective guide block 85, 87. Mounted on each guide block 85, 87 is a pivotable guide rod 89, 91. The pivotable guide rods 89, 91 can each be pivoted by means of a respective pneumatic actuator 93, 95. The pivotable guide rods 89, 91 separate the inner and outer fillets of the breast cap meat. The inner and outer fillet separator 35 harvests an outer fillet by means of its two pivotable guide rods 89, 91 engaging the now loose hanging outer fillet and harvests the outer fillet halves by unloading after the breast cap carrier 17 has passed. Alternatively, the vertical position of the inner and outer fillet separator 35 can be controlled using an automated actuator (not shown). The controller or control system can be configured control the vertical position of the inner and outer fillet separator 35 on the basis of the 3D image and/or 3D model. Also, the controller or control system can be configured to operate the pneumatic actuators 93, 95 on the basis of the 3D image and/or 3D model. For instance, the position relative to a leading end of the breast cap where the pivotable guide rods 89, 91 start engaging the breast cap can be controlled on the basis of the 3D image and/or 3D model.

The tissue cutter 37 shown in FIG. 10 attaches to the common frame beam 40, by means of a base block 97 and mounting strip 57. The base block 97 forms an attachment for opposite actuator carriers 99, 101, which are height adjustably mounted thereto. The vertical position of the actuator carriers 99, 101 can be controlled using an automated actuator (not shown). The controller or control system can be configured control the vertical position of the actuator carriers 99, 101 on the basis of the 3D image and/or 3D model. Bell cranks 103, 105 are pivotally mounted to the opposite actuator carries 99, 101 and can be actuated by respective pneumatic actuator 107, 109 to move tissue cutting knives 111, 113 inwardly and outwardly. The tissue cutter 37 is effective as an inner fillet tendon cutter, and cuts between the carcass and the inner fillet to enable a cleaner harvesting by the carcass separating unit 41, which will finally separate the carcass from the inner fillet and harvests the inner fillet. Also, the controller or control system can be configured to operate the pneumatic actuators 107, 109 on the basis of the 3D image and/or 3D model. For instance, the position relative to a leading end of the breast cap where the cutting knives 111, 113 start engaging the breast cap can be controlled on the basis of the 3D image and/or 3D model.

The third fillet working unit 39 as shown in FIG. 11 has a very similar arrangement as the tissue cutter of FIG. 10. The third fillet working unit 39 uses an identical mounting block 97 carrying identical opposite actuator carriers 99, 101 and bell cranks 103, 105. The bell cranks 103, 105 can be moved by similar pneumatic actuators 107, 109. At their lower ends, however, the bell cranks 103, 105 carry opposite guides 115, 117, which can be moved in and out by the actuators 107, 109. Also, the controller or control system can be configured to control the third fillet working unit 39 similarly to the tissue cutter 37 on the basis of the 3D image and/or 3D model. The third breast fillet working unit 39, which directly precedes the carcass separator 41 associated therewith, centers the inner fillet by pressing against two forwardly protruding bones of the carcass for engagement by the associated carcass separator 41 for enhancing harvesting of the inner fillet.

The carcass separator 41 shown in FIG. 12 is directly associated with the preceding third fillet working unit 39, and has a mounting base 119 for mounting to the common frame beam 40 by means of mounting strips 57. The mounting base 119 again height adjustably carries first and second frame elements 121, 123. The vertical position of the second frame elements 121, 123 can be controlled using an automated actuator (not shown). The controller or control system can be configured control the vertical position of the second frame elements 121, 123 on the basis of the 3D image and/or 3D model. The second frame element 123 is extended upwardly to provide anchorage for a pneumatic actuator 125. The pneumatic actuator 125 acts on an arm 127, which pivots a lifting arm 129 for lifting the carcass remains from the breast cap carrier when it passes underneath the carcass separator 41. The lifting arm 129 is pivoted about a transverse shaft 131. The carcass separator 41 harvests the inner fillet by scraping the now almost loose inner fillet completely loose from the carcass by severing the last remaining tendons retaining to the carcass. Also, the controller or control system can be configured to operate the pneumatic actuator 125 on the basis of the 3D image and/or 3D model. For instance, the position relative to a leading end of the breast cap where the lifting arm 129 start engaging the breast cap can be controlled on the basis of the 3D image and/or 3D model.

Hence there is described a method and device for carrying out the method of mechanically harvesting inner and outer meat fillets from a poultry carcass breast cap. A poultry breast cap 23 is conveyed while being supported inversed to its natural position on a carrier 17 through a path of conveyance 25. The outer fillet is cut along a keel bone of the poultry breast cap 23 to enable separation of the inner and outer fillets. After separation and successive harvesting of the outer and inner breast fillets the carcass remains are discarded. The machine and device 1, 13 for carrying out the method comprises one or more of the various means 15, 17, 29, 31, 33, 35, 37, 39, 41, 43 as described above for performing at least the steps of conveying, separating and harvesting inner and outer breast fillets, and discarding carcass remains.

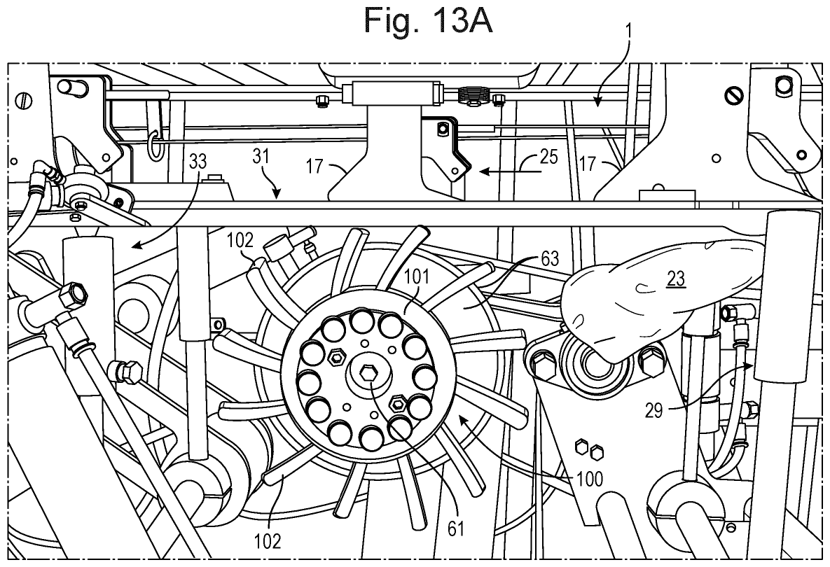

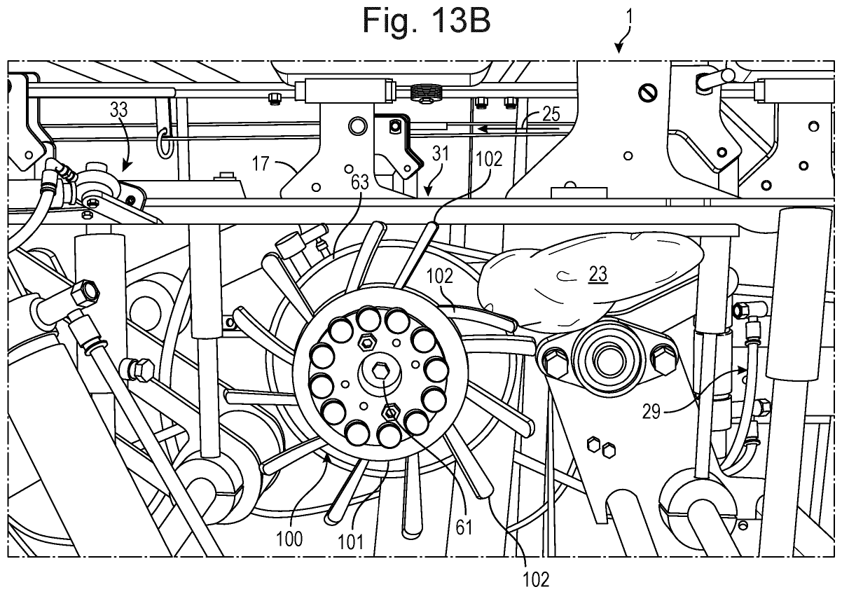

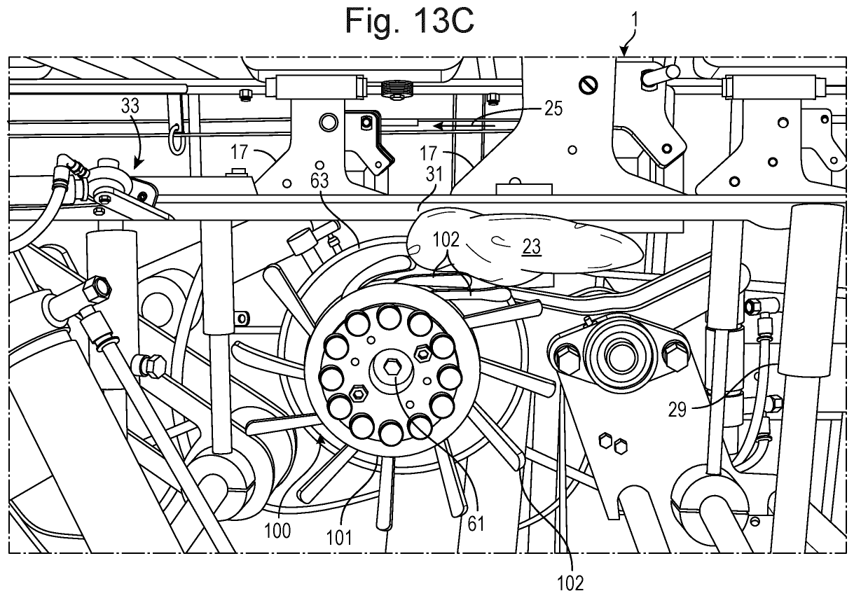

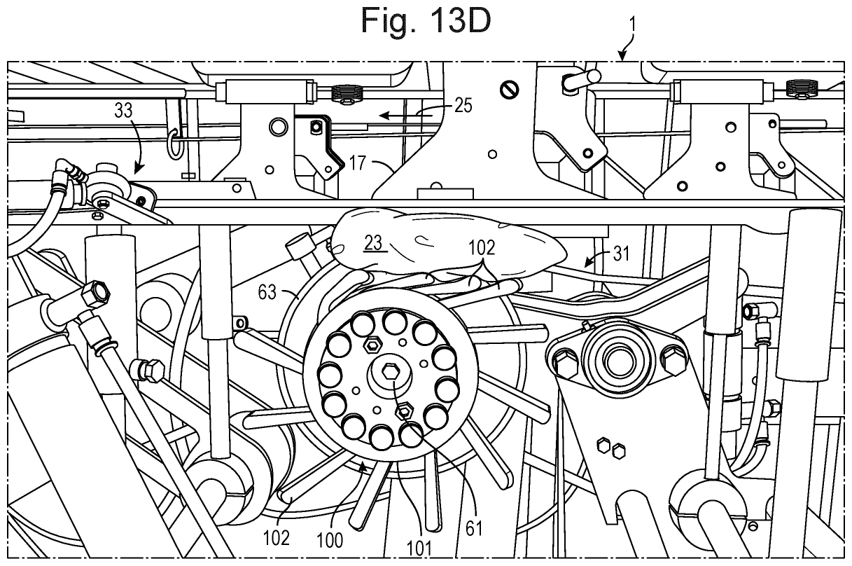

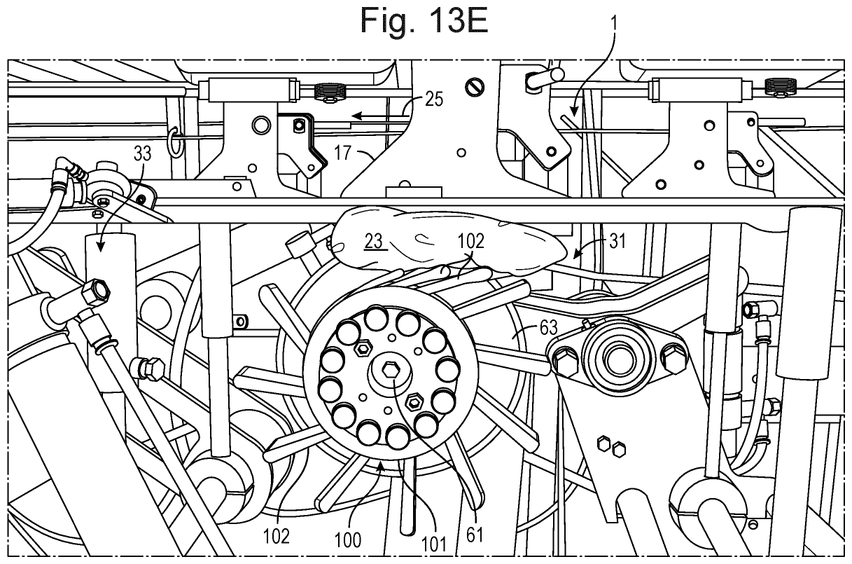

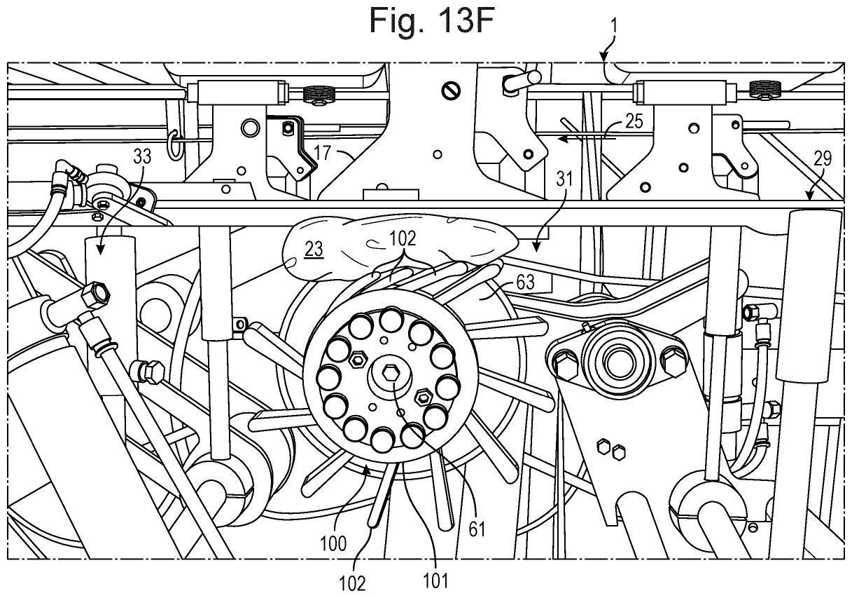

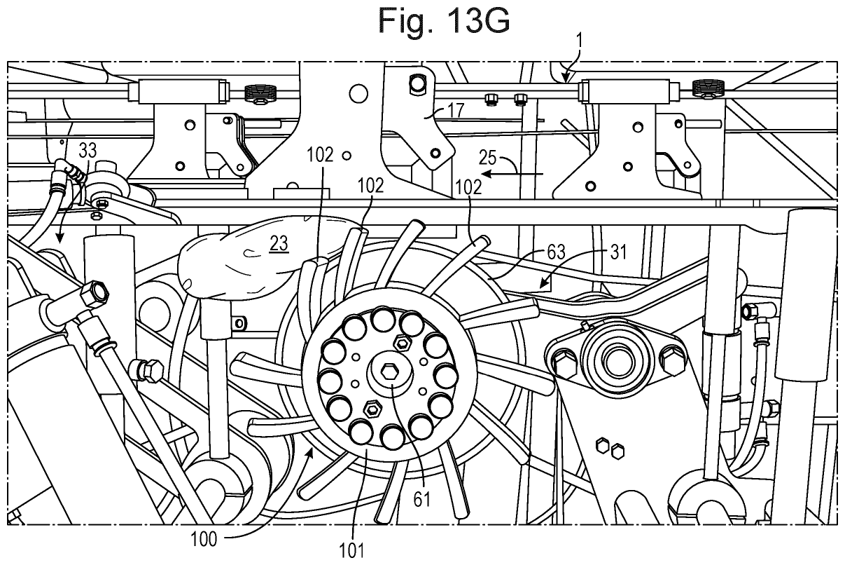

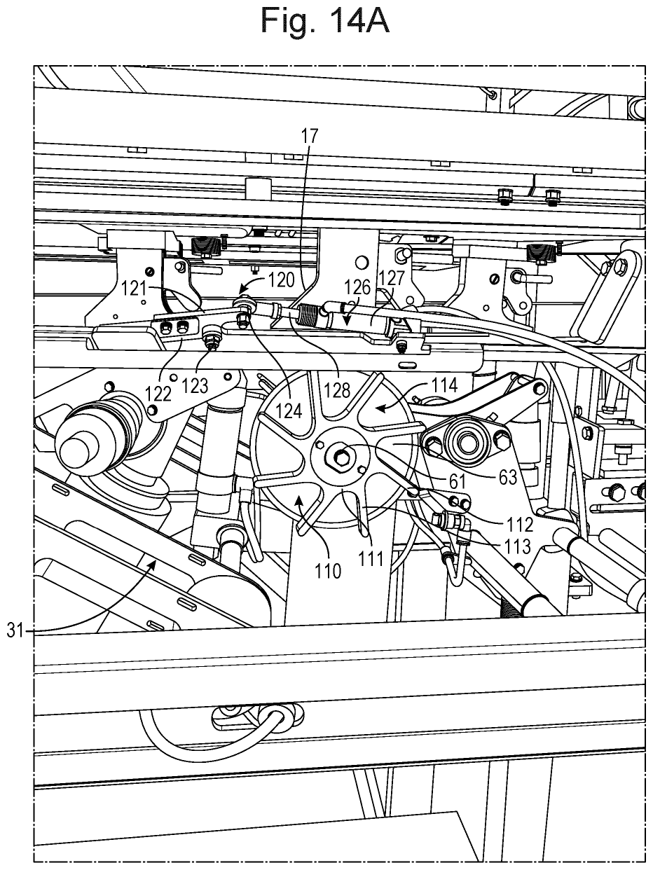

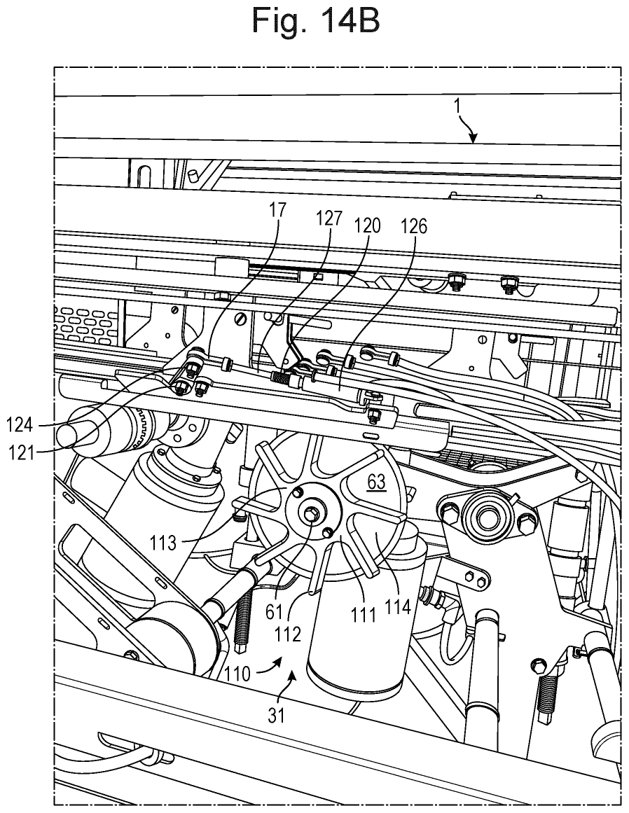

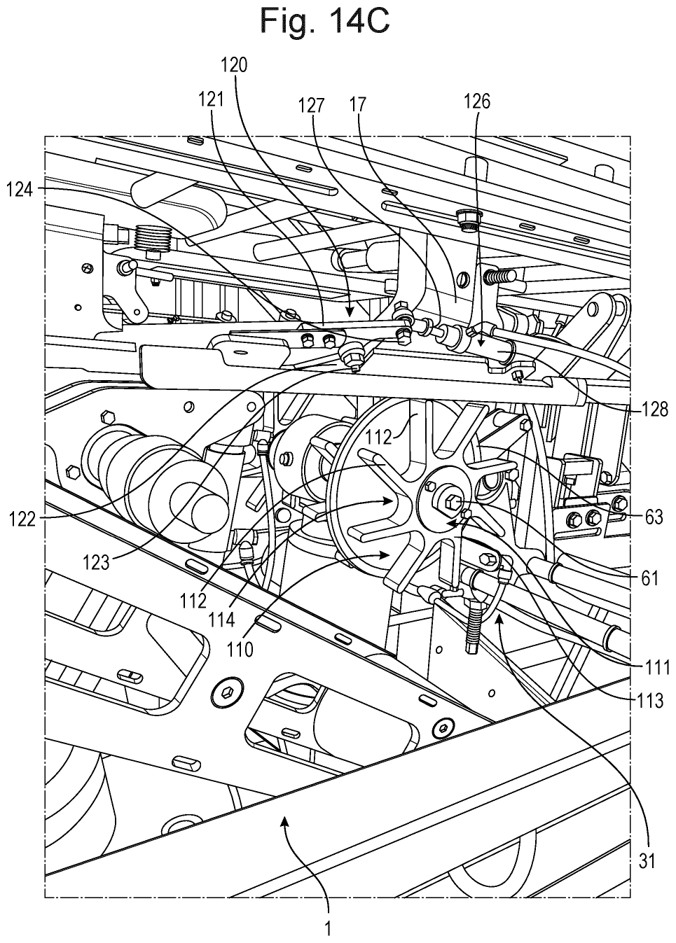

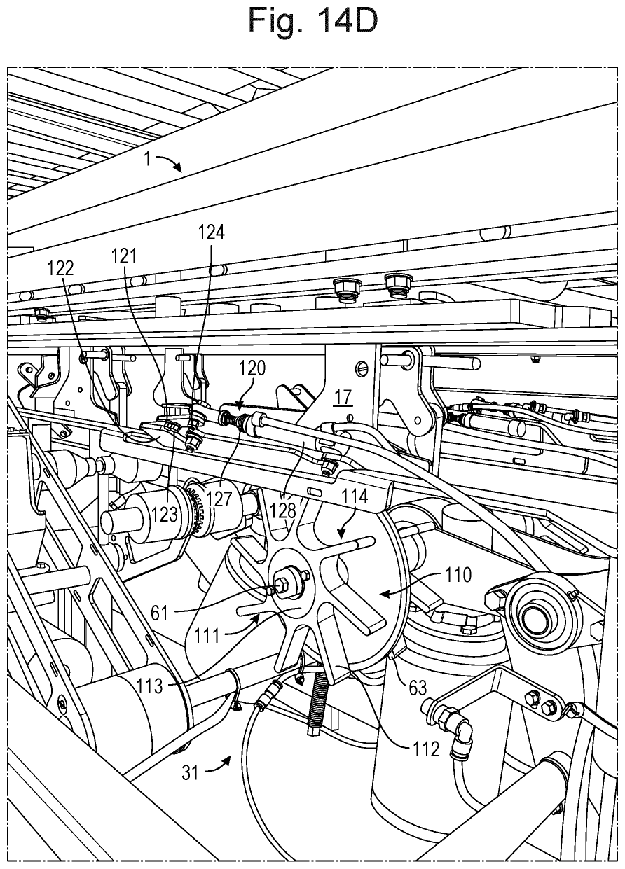

An additional feature for assisting in the cutting of poultry carcasses and harvesting of meat from poultry carcasses is illustrated in FIGS. 13A-15. In one example, a dynamic guide bar system 100 (FIGS. 13A-13G) and 110 (FIGS. 14A-14D) is provided for assisting with the guiding and presentation of portions of a poultry carcass being conveyed through the machine 1 so as to dynamically control the positioning of a poultry carcass and/or portions of the meat of the poultry carcass as the poultry carcass is engaged by cutting blades of the machine to enable enhanced precision or closer cutting of the poultry carcass.

While in one aspect, as shown in FIGS. 13A-13G and 14A-14D, examples of the dynamic guide bar system 100/110 are shown in use with the breast cutter 31 of the machine 1 for engaging and assisting in the cutting of the breast meat from poultry carcass breast caps, it will be understood by those skilled in the art that the dynamic guide bar system illustrated herein can be used in conjunction with a variety of different cutting stations, modules or systems. For example, the dynamic guide bar system 100/110 can be used with cutting/harvesting stations such as the first or second breast fillet working units 29/33 of the machine 1, and/or in other cutting applications wherein it is desirable to manipulate and/or separate portions of the meat of a poultry carcass to enable closer or more precise cutting of the poultry breast cap 23 or other portions of a poultry carcass for harvesting of additional quantities of meat therewith. Still further, the dynamic guide bar system also can be used in other types of poultry or other cutting systems or processing lines, such as for use in splitting or separating whole poultry carcasses.

As generally illustrated in FIGS. 13A-13G, in this example, the dynamic guide bar system 100 generally can comprise a pair of wheels or similar rotatable members 101. In the example illustrated in the figures, the wheels 101 are shown as being rotatably mounted on the driveshaft 61 for the cutting blades 63 of the breast cutter 31 so as to be rotatable therewith. However, the wheels 101 can also be positioned on separate drive shafts. The separate drive shafts can e.g. be positioned coaxial with the drive shaft of the cutting blades. Alternatively, the separate drive shafts can be positioned upstream or downstream and/or higher or lower than the drive shaft of the cutting blades. Preferably, the separate drive shafts are substantially parallel to the drive shaft of the cutting blades. The separate drive shafts are preferably offset relative to the drive shaft of the cutting blades by 10 cm or less, more preferably 5 cm or less, such as 2 cm or less. The wheels generally are spaced from the cutting blades 63, on each side thereof, with each wheel 101 typically being spaced laterally from its adjacent cutting blades by approximately 2 cm, though this spacing can vary as needed to ensure close cutting along the keel bone of the carcass. As further illustrated, each of the wheels 101 includes a series of flexible fingers or other, similar guide bars/members 102. In the example illustrated in FIGS. 13A-13G, the fingers can be mounted in spaced series about the circumference of each wheel 101, extending radially outwardly therefrom.

The fingers 102 and the wheels 101 generally are formed from a food grade rubber or similar flexible food quality material. The fingers also are sufficiently flexible so that as the poultry carcass/breast cap 23 enters the breast cutter 31, the rotation of the fingers 102 will move the fingers into engaging contact with the meat of the breast on either side of the keel bone of the poultry carcass, for example, as illustrated in FIGS. 13A-13B, generally without tearing or otherwise damaging the meat

The number, size, and/or length of the fingers can vary. For example, in some examples, the fingers 102 can be separately mounted to each wheel 101 (e.g., as shown in FIGS. 13A-13G; or the fingers 112 can be formed with the wheels 111 (e.g., as shown in FIGS. 14A-14D). The fingers further can range from approximately 4-6 cm in some examples, to between about 4-10 cm in other examples, and the number of fingers used also can vary depending on the size of the wheels and the application of use (e.g. varying depending on the sizes of carcasses being processed. In this example, the fingers, when fully extended, project beyond an outer edge of the cutting blade, e.g. by 2 to 4 cm. In addition, as indicated in FIGS. 14A-14D, the fingers generally are configured to flex and can be spaced apart so as to catch and/or receive portions of the breast meat therebetween.

As the poultry carcass continues its movement through the breast cutter 31, as illustrated in FIGS.

13C-13E, the flexible fingers 102 of each of the guide wheels 101 will press against and urge the breast meat of the poultry carcass upwardly and outwardly. As a result, the breast meat on either side of the keel bone is urged away from the centerline of the keel bone. Such separation and/or stretching of the breast meat helps ensure that the cutting of the breast fillets is generally maintained substantially in the middle thereof, and helps enable a cleaner and/or more precise cut of the breast meat along and away from the keel bone of the poultry carcass. The poultry breast thus can be cut closer to the keel bone of the poultry carcass to enable more meat to be harvested with each of the breast fillets, while leaving less, potentially wasted meat on the carcass. For example, in some examples, upwards of approximately 10 grams of additional breast meat can be conserved with the breast fillets and harvested from the poultry carcass.

As illustrated in FIG. 13F-13G, as the poultry carcass continues its movement along the path of conveyance 25 through and thereafter downstream and away from the breast cutter 31, the fingers of the dynamic guide bar system 100 generally will release from engagement with the breast meat. If the breast meat has been cut sufficiently to separate fillets therefrom, the fillets can drop of fall into a collection bin or other container. Alternatively, the breast meat can be substantially separated from the carcass, and conveyed, hanging downwardly therefrom, to downstream cutting stations. For example, the poultry carcass can be passed through the downstream second breast fillet working unit (as shown in FIG. 8), and the inner and outer fillet separator 35 (FIG. 1) for further cutting and separation of the breast meat from the carcass and filleting of the breast as described above.

FIGS. 14A-14D illustrate an additional example of a dynamic guide bar system 110. Again, while the example of the dynamic guide bar system 110 of FIGS. 14A-14D is illustrated as generally in use with the optional breast cutter 31 of FIG. 1 of the machine 1, it will be understood by those skilled in the art that this example of the dynamic guide bar system 110 further can be utilized with a variety of different cutting stations or apparatus, as well as for use with different cutting systems, including cut up lines or systems for separating or splitting whole carcasses.

In the example illustrated in FIGS. 14A-14D, the dynamic guide bar system 110 is shown with a pair of wheels 111, each of which has a series of fingers or flexible guide bars 112 substantially integrally formed therewith. The flexible fingers 112 extend radially outwardly from a center hub portion 113 of each wheel, which hub portion generally is mounted along the driveshaft 61 of the cutting blades 63 so that the wheels rotate with the rotation of the cutting blades 63. Each of the wheels also will be spaced apart from the cutting blades, for example, by approximately 2 cm, with such spacing further generally being maintained with any adjustments of the cutting blades. For example, if the cutting blades are adjusted or spaced further or closer apart, the spacing between the cutting blades and the wheels of the dynamic guide bar system generally will be maintained.

As further illustrated in FIGS. 14A-14D, the flexible fingers 112 will extend radially outwardly from the hub portions 113 of the wheels 111. The fingers can extend for approximately between 4 to 6 cm, although greater or lesser lengths can be used. In this example, the fingers, when fully extended, reach approximately to the outer edge of the cutting blade. It will be appreciated that the fingers can also project beyond the edge of the cutting blade, or remain within the contour of the cutting blade. In addition, the number of fingers projecting from each wheel can vary, with the fingers also being spaced apart so as to define a series of recesses 114 therebetween. The recesses 114 generally can be configured so as to receive portions of the meat of the poultry carcass/breast cap therebetween. As a result, portions of the breast meat on either side of the keel bone of the poultry breast cap can be engaged and substantially captured between adjacent fingers within in the recesses 114 defined between such adjacent fingers. Thereafter, as the wheels 111 are rotated with the rotation of the cutting blades, the portions of the breast meat on either side of the keel bone of the poultry breast cap can be lifted, being urged upwardly and being substantially stretched and/or urged outwardly and away from the keel bone so as to help ensure the cutting blades will engage and cut through the middle of the breast meat and substantially along the keel, to help maximize the amount of breast meat that is cut away from the keel bone with the breast fillets, and minimize potentially wasted meat being left along the carcass of the poultry breast.

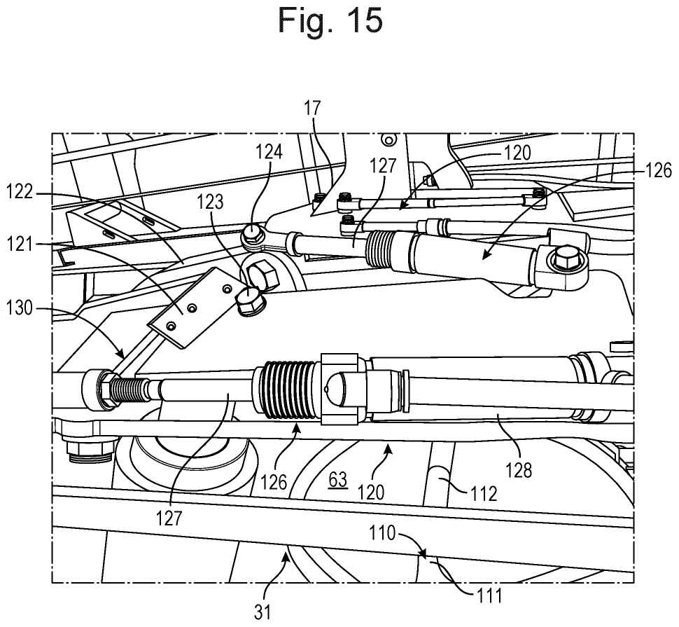

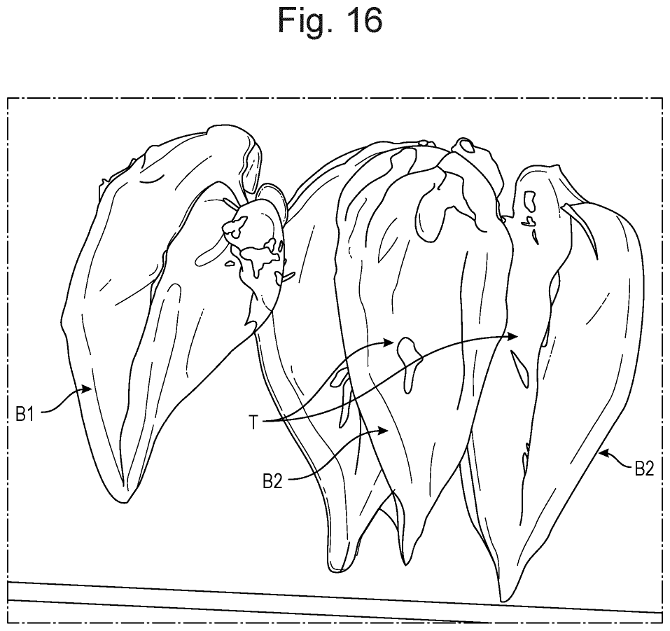

In addition, as further illustrated in FIGS. 14A-15, a pair of adjustable tender guides 120 further can be mounted along each side of the breast cutter 31, generally being arranged slightly downstream from the cutting blades 63 of the breast cutter 31. Each of the tender guides 120 can include a pivoting linkage or arm 121 mounted along a support 122 that can be attached to the frame of the machine 1. Each of the pivoting linkages or arms generally will be pivotally attached to its associated support 122, typically along a mid-portion 123 thereof, and further can be attached at rear end or portion 124 thereof to an actuator 126. For example, as illustrated in FIGS. 14A-15, in some embodiments, the actuator 126 can include a pneumatic cylinder 127 having an extensible cylinder rod 128 that is pivotally attached to the rear or second end 122 of its associated pivoting linkage 121. In addition, other types of actuators such as solenoids or other, similar actuators also can be used. The controller or control system can be configured to operate the tender guides 120 on the basis of the 3D image and/or 3D model.

As further illustrated in FIG. 15, a second or forward end of each of the pivoting linkages or arms 121 can include a cutting blade 130 attached thereto. As the actuators 126 of each tender guide 120 are engaged, the cutting blades 130 attached to the forward or second ends of each of the pivoting linkages or arms will be moved between first, retracted or non-engaging position, and a second, extended or engaging position, whereby the cutting blades will be moved into a position projecting into the path of travel of the poultry breast cap. As the poultry breast caps are moved further downstream through the breast cutter 31, with the breast fillets being cut along the keel bone thereof, the tender portions of the breasts also can be cut and thus maintained with the breast fillets when the cutting blades of the tender guides are in their extended, engaging positions. Alternatively, if, depending upon the application, the tenders are not to be maintained with the breast fillets, but rather are to be cut away separately, the cutting blades of the tender guides 120 can be moved to their retracted, non-engaging positions out of the path of conveyance of the breast caps so that the tender portions of the breast meat can be left with the carcass of the poultry breast cap for later harvesting downstream.

An example of a poultry breast in which the tender portions of the breast fillets are separated therefrom, as compared with breast fillets in which the tender portions are maintained with the breast fillets, is illustrated in FIG. 16. The breast fillet indicated at B1 on the left side of FIG. 16 is shown without a tender portion attached therewith. On the right side of FIG. 16, the breast fillets B2 are shown with tender portions T maintained therewith.

It further will be understood that while examples of the dynamic guide bar system 100 and 110 have been illustrated as including a pair of wheels each having a series of spaced, radially extending flexible fingers or guide bars, various other wheel and/or flexible finger configurations also can be used. As noted, the wheels of the dynamic guide bar system generally will be formed from a flexible food grade material that typically can have a degree of flexibility or compressibility to engage and urge the breast meat of the carcass upwardly and away from the keel bone thereof, but with sufficient resiliency to compress so as to substantially avoid tearing or inappropriate shifting of the breast meat. The dynamic guide bar system further is generally adapted to control or substantially locate the portions of the breast meat away from the keel bone of the poultry carcass, so as to help ensure that the cutting of the breast meat away from the poultry carcass is done substantially along the keel bone, and to avoid portions of the breast meat being inadvertently shifted from one side to the other of a centerline extending along the keel bone, which could result in undesirable cutting of the breast meat that can thus stay with the carcass.

While a setup has been described for separately harvesting outer and inner fillets, it is to be understood that the various implements for performing the breast cap working steps can also be arranged to enable harvesting of half breast fillets with the inner and outer fillet parts attached to one another.

It is thus believed that the operation and construction of the present invention will be apparent from the foregoing description and drawings appended thereto. For the purpose of clarity and a concise description features are described herein as part of the same or separate embodiments, however, it will be appreciated that the scope of the invention may include embodiments having combinations of all or some of the features described. It will be clear to the skilled person that the invention is not limited to any example herein described and that modifications are possible which may be considered within the scope of the appended claims.

Also kinematic inversions are considered inherently disclosed and can be within the scope of the invention. In the claims, any reference signs shall not be construed as limiting the claim. The terms ‘comprising’ and ‘including’ when used in this description or the appended claims should not be construed in an exclusive or exhaustive sense but rather in an inclusive sense. Thus expression as ‘including’ or ‘comprising’ as used herein does not exclude the presence of other elements, additional structure or additional acts or steps in addition to those listed. Furthermore, the words ‘a’ and ‘an’ shall not be construed as limited to ‘only one’, but instead are used to mean ‘at least one’ and do not exclude a plurality. Features that are not specifically or explicitly described or claimed may additionally be included in the structure of the invention without departing from its scope.

Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention. To the extent that structure, material, or acts are considered to be essential they are inexpressively indicated as such. Additions, deletions, and modifications within the purview of the skilled person may generally be made without departing from the scope of the invention, as determined by the claims.

1. A method of harvesting meat fillets from a poultry carcass, comprising supporting a poultry breast cap in a position inverse to a natural position on a carrier moving along a path of conveyance, moving the poultry breast cap past a measuring system configured to detect the poultry breast cap and generate information for determining an approximated size of the poultry breast cap, wherein breast meat is optionally engaged by a dynamic guide bar system and is cut adjacent a keel bone of the poultry carcass, wherein an outer fillet is cut along the keel bone of the poultry breast cap, wherein inner and outer fillets are separated, and wherein remains of the poultry carcass are discarded.

2. The method of claim 1, wherein the measuring system comprises a camera, and further comprising capturing an image of the poultry breast cap with the camera and generating a model approximating a size of the poultry breast cap.

3. The method of claim 1, further comprising providing a first breast fillet working unit having laterally movable tunnel plates, and engaging the breast meat of the poultry breast cap with the tunnel plates.

4. The method of claim 1, further comprising providing a breast cutter configured for cutting the outer fillet along the keel bone of the poultry breast cap.

5. The method of claim 4, wherein the dynamic guide bar system comprises at least one wheel adjacent a cutting blade of the breast cutter and having a series flexible fingers rotatable into engagement with portions of the breast meat of the poultry carcass.

6. The method of claim 1, further comprising providing a second breast fillet working unit having a guide structure and an up-and-down movable engagement member connected to the guide structure, and allowing the guide structure to pass centrally over the carrier to thereby position the engagement member.

7. The method of claim 1, wherein the measuring system includes a 3D imaging system configured for obtaining a three-dimensional, 3D, image of an outer surface of the poultry carcass or the poultry breast cap.

8. The method of claim 7, further including generating a 3D model of the poultry carcass or the poultry breast cap, or a combination thereof, on the basis of the 3D image.

9. The method of claim 7, further comprising determining dimensions, relative locations of anatomical landmarks of the poultry carcass, the breast cap, or a combination thereof, from the 3D image, from the 3D model, or a combination thereof.

10. The method of claim 8, further including adjusting a position of movable parts of a first breast fillet working unit, a breast cutter, a second breast fillet working unit, or a combination thereof, on the basis of the 3D image, the 3D model, or a combination thereof.

11. A method of harvesting meat fillets from a poultry carcass, comprising moving a poultry breast cap supported in a position inverse to a natural position on a carrier moving along a path of conveyance, optionally moving the poultry breast cap past a measuring system configured to detect the poultry breast cap and generate information for determining an approximated size of the poultry breast cap, engaging breast meat of the poultry breast cap with a dynamic guide bar system and cutting the breast meat adjacent a keel bone of the poultry carcass, wherein an outer fillet is cut along the keel bone of the poultry breast cap, wherein inner and outer fillets are separated, and wherein remains of the poultry carcass are discarded.

12. An apparatus for harvesting meat from a poultry carcass, comprising:
an endless conveyor extending along a predefined path of conveyance;
at least one breast cap carrier arranged to move along the predefined path of conveyance by the endless conveyor;
a first breast fillet working unit positioned along the path of conveyance;
a breast cutter downstream of the first breast fillet working unit along the path of conveyance, the breast cutter including a dynamic guide bar system for guiding portions of the meat away from a keel bone of the poultry carcass;
a second fillet working unit downstream of the breast cutter along the path of conveyance;
an inner and outer fillet separator unit downstream of the breast cutter along the path of conveyance;
a third fillet working unit downstream of the inner and outer fillet separator unit along the path of conveyance; and
a carcass separator unit downstream of the third fillet working unit along the path of conveyance.

13. The apparatus of claim 12, wherein the dynamic guide bar system comprises at least one wheel adjacent a cutting blade of the breast cutter and having a series flexible fingers rotatable into engagement with the portions of the meat of the poultry carcass.

14. The apparatus of claim 12, further comprising a carcass unloader downstream of the carcass separator unit in the path of conveyance defined by the conveyor.

15. The apparatus of claim 12, further comprising a tissue cutting unit downstream of the inner and outer fillet separator along the path of conveyance, and a third fillet working unit downstream of the tissue cutting unit along the path of conveyance.

16. The apparatus of claim 12, further comprising a common frame beam extending parallel to the path of conveyance and mounting strips engaging over the common frame beam and configured for mounting one or more of the endless conveyor, the inner and outer fillet separator unit for separating inner and outer breast fillets, and a carcass unloader configured for discarding carcass remains.

17. The apparatus of claim 12, wherein the breast cutter comprises a motor drive unit for rotatably driving a pair of cutting blades.

18. The apparatus of claim 12, further comprising a camera arranged along the path of conveyance for imaging the poultry carcass for determining an approximate size thereof.

19. An apparatus for harvesting meat from a poultry carcass, comprising:
an endless conveyor extending along a predefined path of conveyance;
at least one breast cap carrier adapted to be moved along the predefined path of conveyance by the endless conveyor;
a measuring system for detecting a poultry breast cap and generating information for determining an approximated size of the poultry breast cap;
a first breast fillet working unit positioned along the path of conveyance;
a breast cutter downstream of the first breast fillet working unit along the path of conveyance;
a second fillet working unit downstream of the breast cutter along the path of conveyance;
an inner and outer fillet separator unit downstream of the breast cutter along the path of conveyance;
a third fillet working unit downstream of the inner and outer fillet separator unit along the path of conveyance; and
a carcass separator unit downstream of the third fillet working unit along the path of conveyance.

20. The apparatus of claim 19, wherein the measuring system includes a 3D imaging system configured for obtaining a 3D image of an outer surface of the poultry carcass, the poultry breast cap, or a combination thereof.

21. The apparatus of claim 20, including a processor configured for generating a 3D model of the poultry carcass, the poultry breast cap, or a combination thereof, on the basis of the 3D image.

22. The apparatus of claim 21, including a processor configured for determining dimensions and/or locations of anatomical landmarks of the poultry carcass, the breast cap, or a combination thereof, from the 3D image, from the 3D model, or a combination thereof.

23. The apparatus of claim 21, wherein a position of movable parts of the first breast fillet working unit, the breast cutter, the second breast fillet working unit, or a combination thereof, is adjusted on the basis of the 3D image, the 3D model, or a combination thereof.
